(19) United States
(12) Patent Application Publication
(10) Pub. No.: US 2015/0117819 A1
(43) Pub. Date: Apr. 30, 2015

(54) PLUGGABLE OPTICAL TRANSCEIVER MODULE

(71) Applicant: Ming-Feng HO, HSINCHU COUNTY (TW)

(72) Inventor: Hui-Tsuo CHOU, HSINCHU COUNTY (TW)

(73) Assignee: Ming-Feng Ho, HSINCHU COUNTY (TW)

(21) Appl. No.: 14/067,990

(22) Filed: Oct. 31, 2013

(51) Int. Cl. G02B 6/42

(52) U.S. Cl. CPC G02B 6/42
USPC 385/76

(57) ABSTRACT

A pluggable optical transceiver module, connected to an optical signal interface which has an elastic plate having an aperture, includes a connector, a first cover, a second cover, a first fastening member, and a second fastening member. The connector includes a fixing block. The fixing block further has first and second fastening holes inwardly formed from the first and second surfaces of the fixing block, respectively. The first cover abuts against the first surface and has a first through hole communicated with the first fastening hole. The second cover abuts against the second surface and has a second through hole communicated with the second fastening hole. The second cover includes a first engaging block engaged in the aperture. The first and second fastening members are respectively fastened to the first and second fastening holes respectively via the first and second through holes.

### BACKGROUND

1. Technical Field

The present disclosure relates to a pluggable optical transceiver module, and more particularly, to a small form-factor pluggable optical transceiver module.

2. Description of Related Art

Updated optical fiber communication has advantages of high bandwidth, light weight, high signal accuracy, long transmission distance, resistance to interference of external electromagnetic waves, etc. In general, an optical fiber cable that is used to transmit optical signals has a first connecting unit, and signal transceiving equipment that is used to receive the optical signals has a second connecting unit, in which the first connecting unit can be plugged into and fixed to the second connecting unit.

The first connecting unit of the optical fiber cable generally includes a connector for plugging, and includes an upper cover and a lower cover for clamping the connector. The upper cover and the lower cover are fastened to each other by screws. Therefore, the upper cover and the lower cover can firmly fix the connector.

However, if a screw is used to fasten the upper cover to the lower cover, the length of the screw must be long enough, which may limit the species of screw to be used and result in the breakage of the screw in use.

Furthermore, how to effectively fix the first connecting unit to the second connecting unit and how to rapidly separate first connecting unit from the second connecting unit are issues that the manufacturers desperately put effort into for improvement.

### SUMMARY

In order to solve the problems of the prior art, the disclosure provides an improved pluggable optical transceiver module. Particularly, the pluggable optical transceiver module is adapted to connect an optical signal interface. The optical signal interface has an elastic plate. The elastic plate has an aperture. The small form-factor pluggable transceiver includes a connector, a first cover, a second cover, a first fastening member, and a second fastening member. The connector is used to connect an optical fiber cable and includes a fixing block. The fixing block has a first surface and a second surface. The first surface and the second surface are respectively located at two opposite sides of the fixing block. The fixing block further has a first fastening hole and a second fastening hole. The first fastening hole and the second fastening hole are inwardly formed from the first surface and the second surface, respectively. The first cover abuts against the first surface and has a first through hole. The first through hole is communicated with the first fastening hole. The second cover abuts against the second surface and has a second through hole. The second through hole is communicated with the second fastening hole. The second cover includes a first engaging block. The first engaging block is engaged in the aperture. The first fastening member is fastened to the first fastening hole via the first through hole, so as to fix the first cover to the fixing block. The second fastening member is fastened to the second fastening hole via the second through hole, so as to fix the second cover to the fixing block.

In an embodiment of the disclosure, the second cover has an inner surface and an outer surface. The first engaging block is located at the outer surface. The second cover has a slot. The slot runs through the second cover and is adjacent to the first engaging block. The pluggable optical transceiver module further includes a handle and a linking-up member. The handle includes a pivot rod. The pivot rod is pivotally disposed at the inner surface and has a protruding portion. The linking-up member is pivotally disposed at the inner surface and has a first end and a second end. The protruding portion is located between the inner surface and the first end, and the second end is located over the slot. When the pivot rod rotates to make the protruding portion push the first end, the linking-up member is forced to rotate, so as to make the second end protrude out of the second cover via the slot and push the elastic plate to make the aperture leave the first engaging block.

In an embodiment of the disclosure, the inner surface of the second cover abuts against the second surface, so as to make the pivot rod and the linking-up member be retained between the second cover and the fixing block.

In an embodiment of the disclosure two ends of the pivot rod protrude out of two opposite sides of the second cover. The handle further includes two side rods and a sleeve. The side rods are respectively connected to two ends of the pivot rod. The side rods respectively have two end portions that extend to each other. The end portions are respectively sleeved in the sleeve from two ends of the sleeve.

In an embodiment of the disclosure, the pivot rod, the side rods, and the sleeve form a ring, and the handle surrounds a periphery of the connector.

In an embodiment of the disclosure, the first cover includes a second engaging block for engaging the sleeve.

In an embodiment of the disclosure, the first fastening hole and the second fastening hole are communicated with each other.

In an embodiment of the disclosure, the pluggable optical transceiver module further includes an optical signal processing portion. The optical signal processing portion is connected to the first cover and detachably accommodated in the optical signal interface.

In an embodiment of the disclosure, the connector is a ST (Straight Tip) connector.

In an embodiment of the disclosure, the connector and the optical fiber cable integrally form an AOC (Active Optical Cable).

In an embodiment of the disclosure, the first fastening member and the second fastening member are two screws, and the first fastening hole and the second fastening hole are two screw holes.

In an embodiment of the disclosure the first fastening member and the second fastening member integrally form a rivet.

It can be seen that the pluggable optical transceiver module of the disclosure uses the first fastening member to fasten the first cover to the first surface of the fixing block of the connector, and uses the second fastening member to fasten the second cover to the second surface of the fixing block. Accordingly, the first cover and the second cover can be fastened to the connector respectively by using the first fastening member and the second fastening member with short lengths. The first fastening member and the second fastening member with short lengths not only can achieve the purpose of making the first cover and the second cover clamp the connector, but also have better mechanical strengths and uneasy to be broken. Moreover, the pluggable optical transceiver module of the disclosure provides a separation mechanism design for separating from the optical signal interface. The separation mechanism design is convenient to users and effectively reduces the operating time of separating the pluggable optical transceiver module from the optical signal interface.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a perspective view of a pluggable optical transceiver module and an optical signal interface according to an embodiment of the disclosure;

FIG. 2 is an exploded view of the pluggable optical transceiver module in FIG. 1;

FIG. 3 is another exploded view of the pluggable optical transceiver module in FIG. 1;

FIG. 4A is a top view of the pluggable optical transceiver module in FIG. 1 and an optical signal interface after connecting, in which the handle and the second engaging block are engaged to each other;

FIG. 4B is a sectional view of FIG. 4A along line 4B-4B′;

FIG. 5A is a top view of the pluggable optical transceiver module in FIG. 1 and the optical signal interface after connecting, in which the handle is not engaged to the second engaging block;

FIG. 5B is a sectional view of FIG. 5A along line 5B-5B′;

FIG. 6 is another sectional view of FIG. 4A along line 6-6′;

FIG. 7 is another sectional view of FIG. 6;

FIG. 8 is a perspective view of a pluggable optical transceiver module and the optical signal interface according to another embodiment of the disclosure; and

FIG. 9 is a perspective view of a pluggable optical transceiver module and the optical signal interface according to another embodiment of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

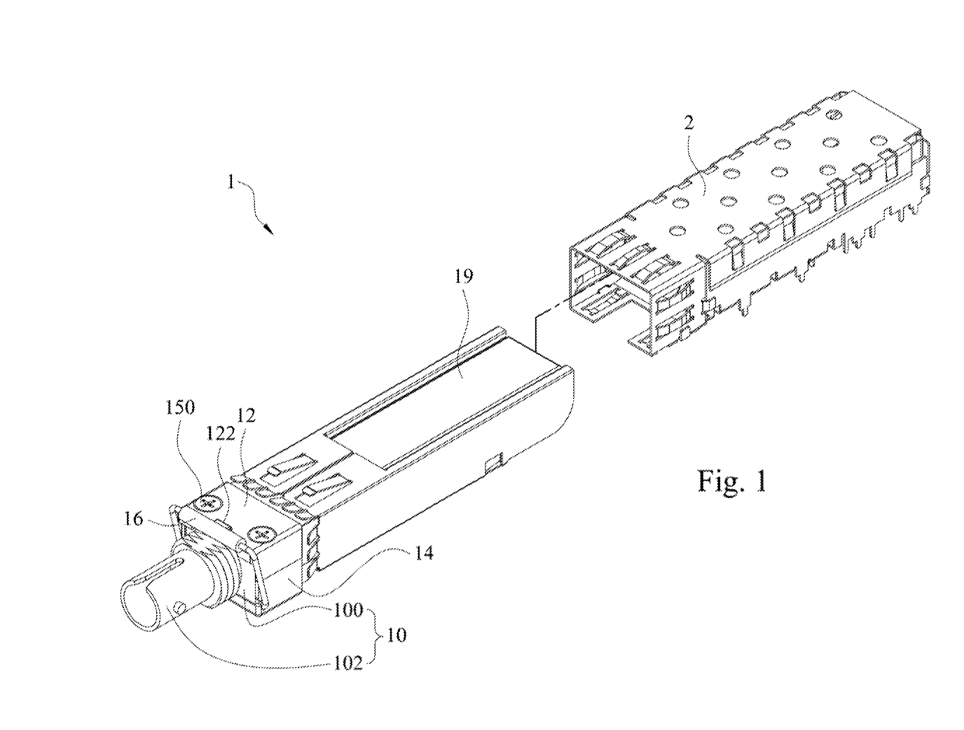

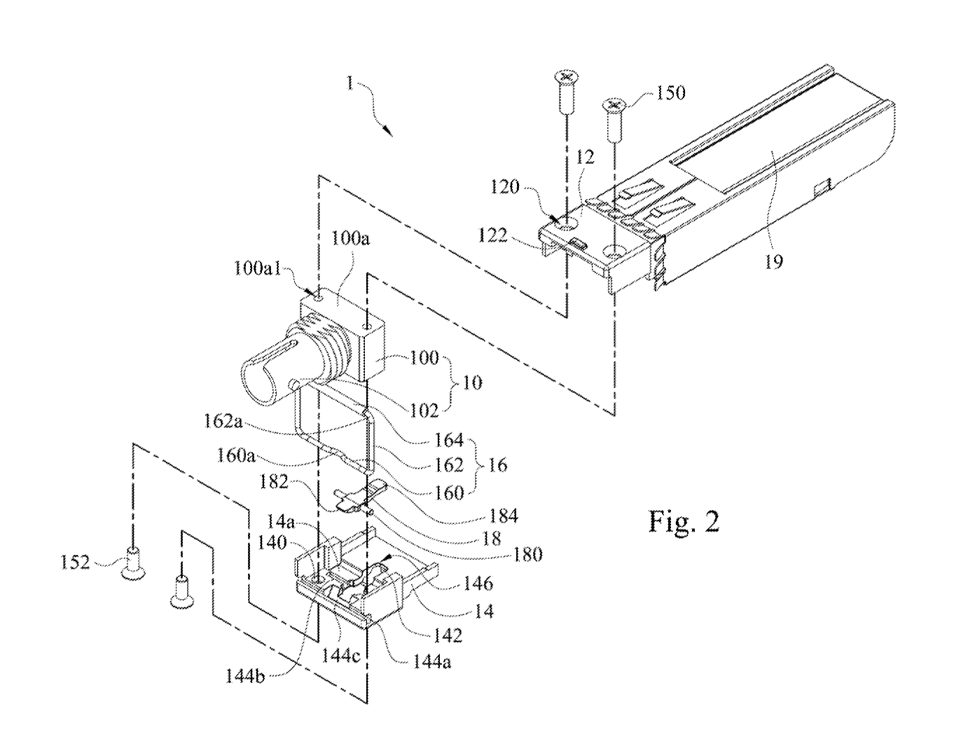

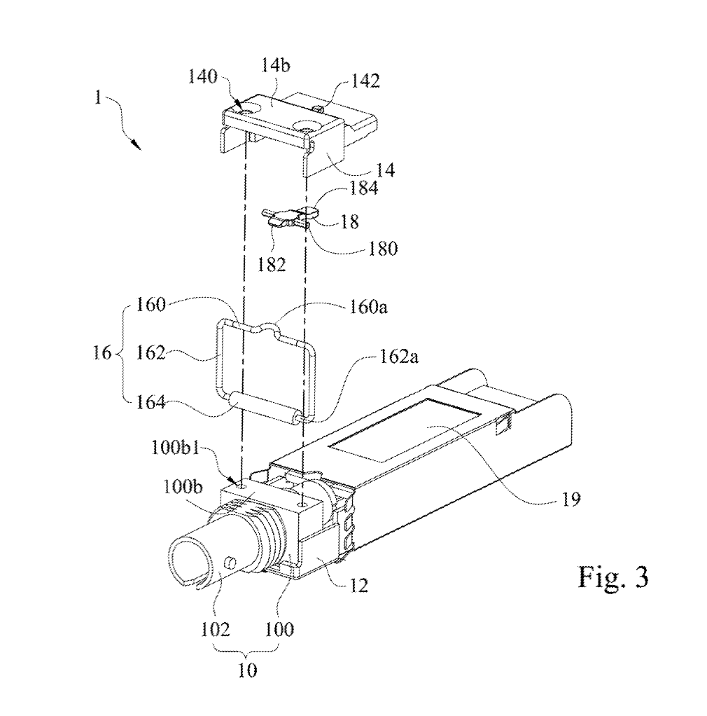

FIG. 1 is a perspective view of a pluggable optical transceiver module 1 and an optical signal interface 2 according to an embodiment of the disclosure. FIG. 2 is an exploded view of the pluggable optical transceiver module 1 in FIG. 1. FIG. 3 is another exploded view of the pluggable optical transceiver module 1 in FIG. 1.

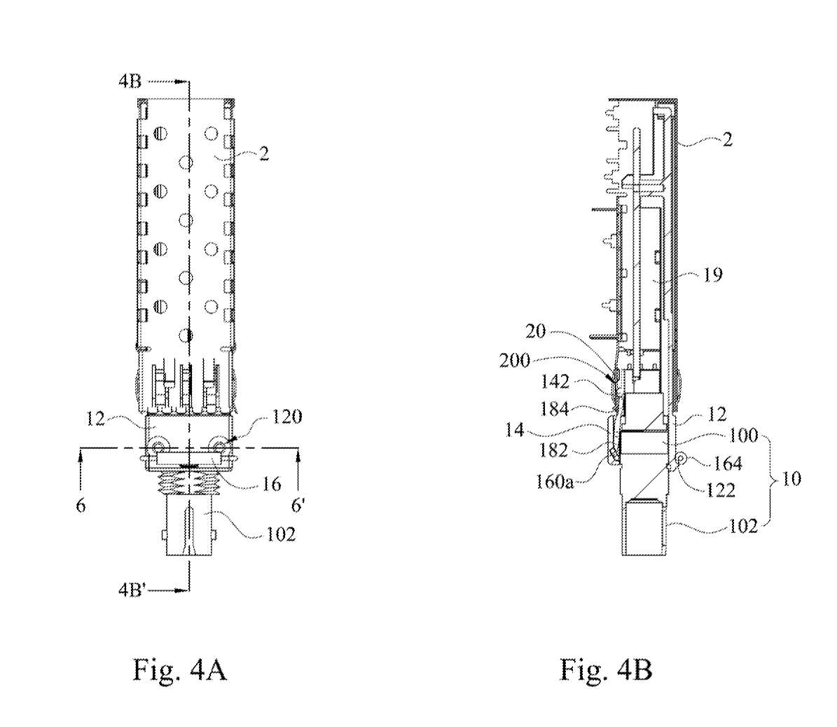

As shown in FIG. 1, the optical signal interface 2 can be an optical fiber signal interface disposed on any equipment. The optical signal interface 2 can be located at a side surface of the equipment for the pluggable optical transceiver module 1 of the disclosure to pluggably connect. The optical signal interface 2 has an elastic plate 20 (as shown in FIG. 4A and FIG. 4B). The elastic plate 20 is located at an edge of the optical signal interface 2. The elastic plate 20 has an aperture 200 (as shown in FIG. 4A and FIG. 4B).

As shown in FIG. 2 and FIG. 3, the pluggable optical transceiver module 1 includes a connector 10, a first cover 12, a second cover 14, a first fastening member 150, a second fastening member 152, and an optical signal processing portion 19. The connector 10 of the pluggable optical transceiver module 1 includes a fixing block 100 and has a receptacle 102. The fixing block 100 and the receptacle 102 are respectively located at two sides of the connector 10. The receptacle 102 of the connector 10 is for an optical fiber cable (not shown) to plug. In the embodiment of the disclosure, the connector 10 is a ST (Straight Tip) connector, but the disclosure is not limited in this regard.

The optical signal processing portion 19 of the pluggable optical transceiver module 1 is connected to the first cover 12 and is optically coupled to the optical fiber cable, so as to receive optical signals transmitted by the optical fiber cable or to inversely transmit optical signals to the optical fiber cable. When the pluggable optical transceiver module 1 of the disclosure is connected to the optical signal interface 2, the optical signal processing portion 19 is accommodated in the optical signal interface 2, so as to exchange optical signals. In other words, the optical signal processing portion 19 is a relay station of optical signals between the optical fiber cable and the optical signal interface 2.

The fixing block 100 of the connector 10 has a first surface 100a and a second surface 100b. The first surface 100a and the second surface 100b are respectively located at two opposite sides of the fixing block 100. The fixing block 100 further has a first fastening hole 100a1 and a second fastening hole 100b1. The first fastening hole 100a1 and the second fastening hole 100b1 are inwardly formed from the first surface 100a and the second surface 100b, respectively.

As shown in FIG. 1 and FIG. 2, the first cover 12 of the pluggable optical transceiver module 1 abuts against the first surface 100a of the fixing block 100 and has a first through hole 120. Furthermore, the structure of the first cover 12 is designed to engage the first surface 100a of the fixing block 100. When the first cover 12 and the fixing block 100 of the connector 10 are engaged to each other, the first through hole 120 of the first cover 12 is communicated with the first fastening hole 100a1 of the fixing block 100. Therefore, the first cover 12 can be fixed to the fixing block 100 by passing the first fastening member 150 through the first through hole 120 of the first cover 12 and then fastening the first fastening member 150 to the first fastening hole 100a1 of the fixing block 100.

As shown in FIG. 3, the second cover 14 of the pluggable optical transceiver module 1 abuts against the second surface 100b of the fixing block 100 and has a second through hole 140. The structure of the second cover 14 is designed to engage the second surface 100b of the fixing black 100. When the second cover 14 and the fixing block 100 of the connector 10 are engaged to each other, the second through hole 140 of the second cover 14 is communicated with the second fastening hole 100b1 of the fixing block 100. Therefore, the second cover 14 can be fixed to the fixing block 100 by passing the second fastening member 152 through the second through hole 140 of the second cover 14 and then fastening the second fastening member 152 to the second fastening hole 100b1 of the fixing block 100.

In the embodiment of the disclosure, as shown in FIG. 2, the first fastening member 150 and the second fastening member 152 of the pluggable optical transceiver module 1 are two screws, and the first fastening hole 100a1 and the second fastening hole 100b1 are two screw holes, but the disclosure is not limited in this regard.

FIG. 4A is a top view of the pluggable optical transceiver module 1 in FIG. 1 and an optical signal interface 2 after connecting, in which the handle 16 and the second engaging block 122 are engaged to each other. FIG. 4B is a sectional view of FIG. 4A along line 4B-4B′.

As shown in FIG. 3 and FIG. 4B, the second cover 14 of the pluggable optical transceiver module 1 includes a first engaging block 142. When the pluggable optical transceiver module 1 is connected to the optical signal interface 2, the first engaging block 142 of the second cover 14 is engaged in the aperture 200 of the elastic plate 20.

As shown in FIG. 2 and FIG. 3, the second cover 14 of the pluggable optical transceiver module 1 has an inner surface 14a and an outer surface 14b. The first engaging block 142 of the second cover 14 is located at the outer surface 14b. The second cover 14 further has a first groove 144a, a second groove 144b, a space 144c, and a slot 146. The first groove 144a, the second groove 144b, and the space 144c are formed at the inner surface 14a, and the space 144c is located between the first groove 144a and the second groove 144b. The slot 146 of the second cover 14 runs through the second cover 14 (i.e., the slot 146 communicates the inner surface 14a and the outer surface 14b) and is adjacent to the first engaging block 142.

The pluggable optical transceiver module 1 further includes a handle 16 and a linking-up member 18. The handle 16 of the pluggable optical transceiver module 1 includes a pivot rod 160, two side rods 162, and a sleeve 164. The pivot rod 160 of the handle 16 is pivotally disposed at the first groove 144a on the inner surface 14a and has a protruding portion 160a. The protruding portion 160a of the pivot rod 160 is the portion that is not pivotally connected at the first groove 144a of the second cover 14. Two ends of the pivot rod 160 protrude out of two opposite sides of the second cover 14. The side rods 162 of the handle 16 are respectively connected to two ends of the pivot rod 160. The side rods 162 respectively have two end portions 162a that extend to each other. The end portions 162a are respectively sleeved in the sleeve 164 of the handle 16 from two ends of the sleeve 164.

The linking-up member 18 of the pluggable optical transceiver module 1 includes a pivot 180. The pivot 180 of the linking-up member 18 is pivotally disposed at the second groove 144b on the inner surface 14a and has a first end 182 and a second end 184. The protruding portion 160a of the handle 16 and the first end 182 of the linking-up member 18 protrude into the space 144c between the first groove 144a and the second groove 144b, and the protruding portion 160a is located between the inner surface 14a and the first end 182. The second end 184 of the linking-up member 18 is located over the slot 146 of the second cover 14.

When the second cover 14 and the fixing block 100 of the connector 10 are engaged to each other, the inner surface 14a of the second cover 14 abuts against the second surface 100b of the fixing block 100, so as to make the pivot rod 160 of the handle 16 and the linking-up member 18 be retained between the second cover 14 and the fixing block 100. In other words, the handle 16 and the linking-up member 18 are assembled when the second cover 14 and the fixing block 100 of the connector 10 are engaged to each other.

However, the ways by which the pivot rod 160 of the handle 16 and the linking-up member 18 are pivotally disposed at the second cover 14 are not limited by figures of the disclosure.

In the embodiment of the disclosure, the pivot rod 160, the side rods 162, and the sleeve 164 form a ring, and the handle 16 surrounds periphery of the connector 10. During the rotation of the pivot rod 160 of the handle 16 relative to the second cover 14, the sleeve 164 is retained by the outer wall of the receptacle 102 or the first cover 12, so the handle 16 rotates limitedly.

Furthermore, as shown in FIG. 4A and FIG. 4B, the first cover 12 of the pluggable optical transceiver module 1 further includes a second engaging block 122 for engaging the sleeve 164 of the handle 16. When the sleeve 164 of the handle 16 and the second engaging block 122 of the first cover 12 are engaged to each other, the protruding portion 160a of the pivot rod 160 that is located in the space 144c does not contact the first end 182 of the linking-up member 18 (in another embodiment, the protruding portion 160a can contact the first end 182), and the first engaging block 142 that is located at the outer surface 14b of the second cover 14 is still engaged to the aperture 200 of the elastic plate 20. Furthermore, the second engaging block 122 of the first cover 12 can be regarded as a structure for fixing the handle 16, so as to prevent the handle 16 from rotating.

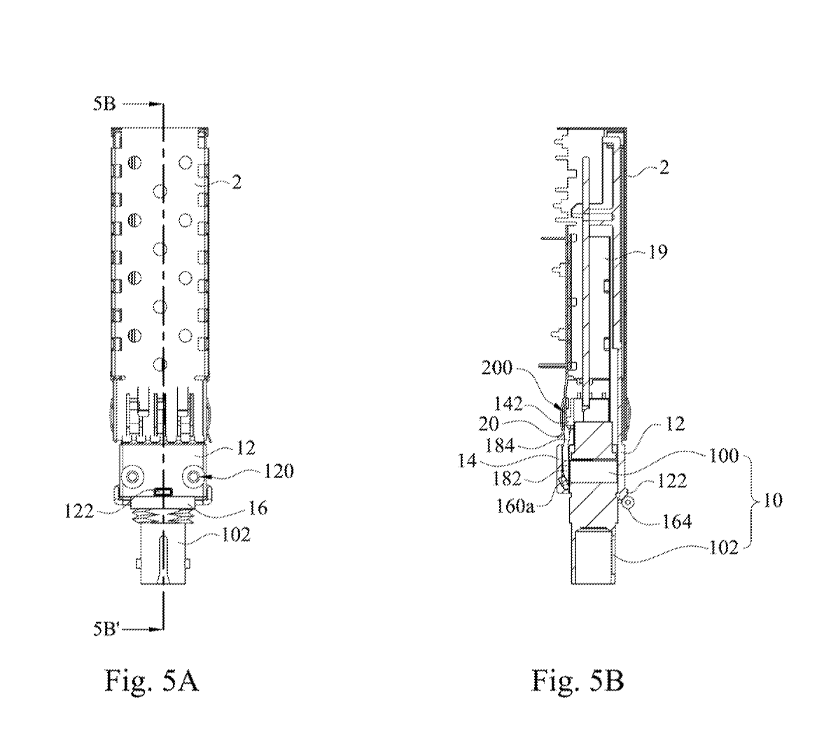

FIG. 5A is a top view of the pluggable optical transceiver module 1 in FIG. 1 and the optical signal interface 2 after connecting, in which the handle 16 is not engaged to the second engaging block 122. FIG. 5B is a sectional view of FIG. 5A along line 5B-5B′.

As shown in FIG. 5A and FIG. 5B, when the pivot rod 160 of the handle 16 rotates relative to the second cover 14 to make the sleeve 164 of the handle 16 separate from the second engaging block 122 of the first cover 12, the protruding portion 160a of the pivot rod 160 that is located in the space 144c pushes the first end 182 of the linking-up member 18, and then the linking-up member 18 is forced to rotate relative to the second cover 14 by the pivot 180. Meanwhile, the second end 184 of the linking-up member 18 protrudes out of the second cover 14 via the slot 146 and pushes the elastic plate 20 to make the aperture 200 leave the first engaging block 142. In other words, the way the linking-up member 18 rotates relative to the second cover 14 is like the way a seesaw rotates. Therefore, the pluggable optical transceiver module 1 can separate from the optical signal interface 2.

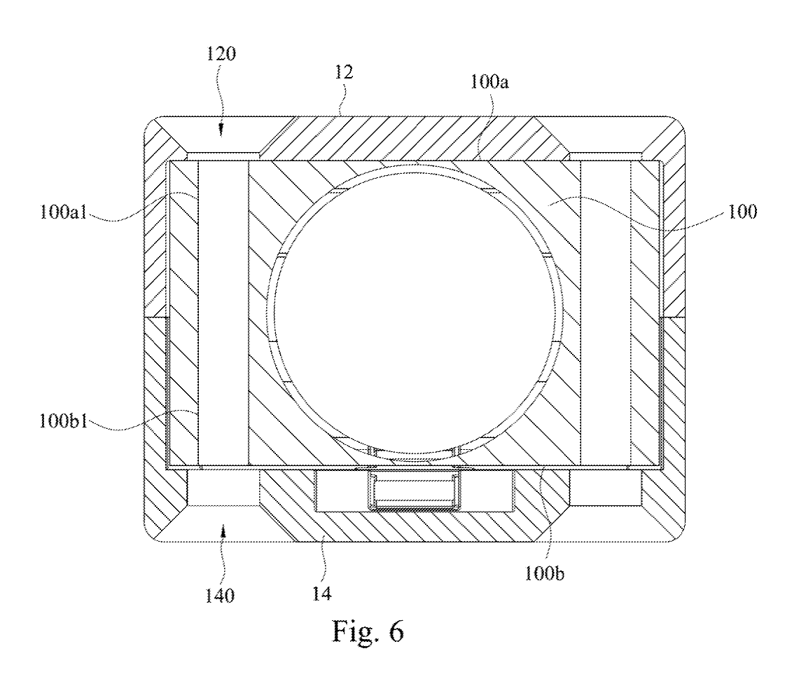

FIG. 6 is another sectional view of FIG. 4A along line 6-6′.

As shown in FIG. 6, the first fastening hole 100a1 and the second fastening hole 100b1 of the fixing block 100 are communicated with each other. Therefore when manufacturing the fixing block 100, the first fastening hole 100a1 and the second fastening hole 100b1 can be manufactured by directly penetrating the fixing block 100, so the cost of manufacturing can be saved.

However, the disclosure is not limited in this regard. In another embodiment of the disclosure, if the cost is not concerned or certain structural design must be complied with, the first fastening hole 100a1 and the second fastening hole 100b1 of the fixing block 100 can be not communicated with each other.

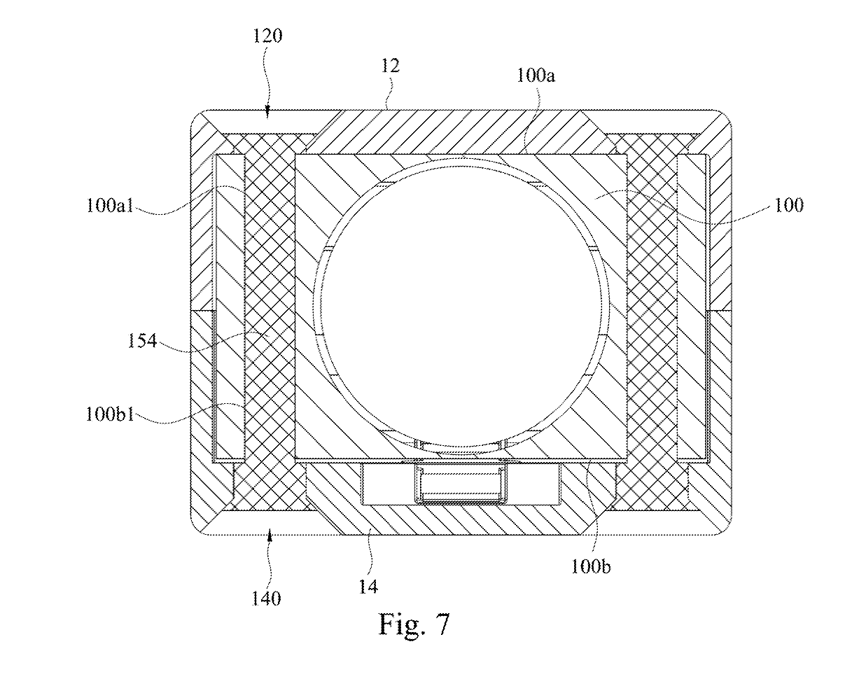

FIG. 7 is another sectional view of FIG. 6.

As shown in FIG. 7, the first fastening member 150 that is originally used to fixing the first cover 12 to the fixing block 100 and the second fastening member 152 (as shown in FIG. 2) that is originally used to fixing the second cover 14 to the fixing block 100 can be replaced by an integrally formed rivet 154. During assembling, the rivet 154 can be inserted into the first fastening hole 100a1 of the fixing block 100 via the first through hole 120 of the first cover 12, or be inserted into the second fastening hole 100b1 of the fixing block 100 via the second through hole 140 of the second cover 14. Subsequently, two ends of the rivet 154 are respectively riveted to the first through hole 120 of the first cover 12 and the second through hole 140 of the second cover 14, so as to achieve the purpose of fixing the first cover 12 and the second cover 14 to the fixing block 100.

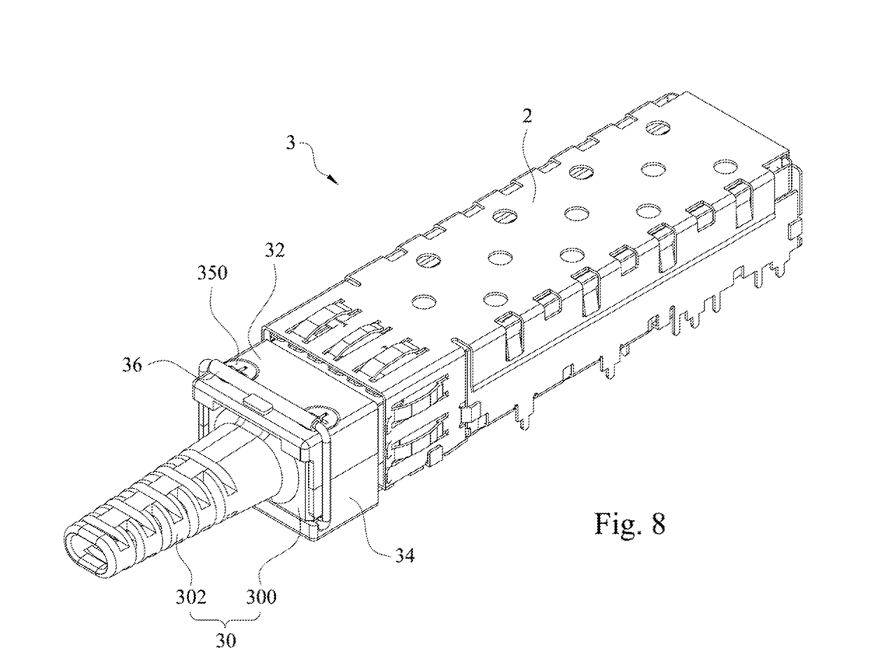

FIG. 8 is a perspective view of a pluggable optical transceiver module 3 and the optical signal interface 2 according to another embodiment of the disclosure.

As shown in FIG. 8, the pluggable optical transceiver module 3 includes a connector 3, a first cover 32, a second cover 34, a first fastening member 350, a second fastening member (not shown, but can refer to FIG. 2), a handle 36, a linking-up member (not shown, but can refer to FIG. 2), and an optical signal processing portion (not shown, but can refer to FIG. 2). The structures and functions of the components and relationships among the components can refer to related descriptions of the pluggable optical transceiver module 1 above and are not described there again.

It should be pointed out that the connector 30 of the pluggable optical transceiver module 3 includes a fixing block 300 and a cladding portion 302. The cladding portion 302 is used to clad an optical cable. Therefore, the fixing block 300 of the connector 30 and the optical fiber cable integrally form an AOC (Active Optical Cable).

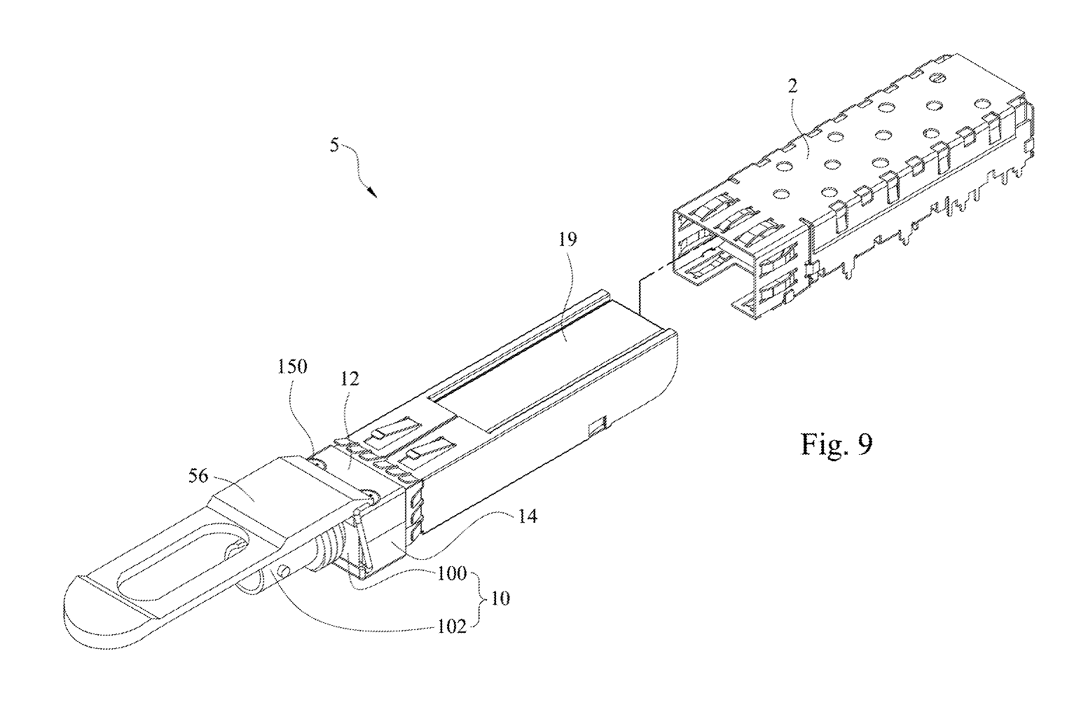

FIG. 9 is a perspective view of a pluggable optical transceiver module 5 and the optical signal interface 2 according to another embodiment of the disclosure.

As shown in FIG. 9, the pluggable optical transceiver module 5 includes the connector 10, the first cover 12, the second cover 14, the first fastening member 150, a second fastening member (not shown, but can refer to FIG. 2), a linking-up member (not shown, but can refer to FIG. 2), and an optical signal processing portion (not shown, but can refer to FIG. 2) similar to those of the embodiment in FIG. 1, so the structures and functions of the components and relationships among the components can refer to related descriptions of the pluggable optical transceiver module 1 above and are not described there again.

It should be pointed out that the pluggable optical transceiver module 5 further includes a handle 56 of which the appearance is like a pull ring, so the handle 56 is convenient for users to hold and thus easily achieving the purpose of rotating the handle 56.

According to the foregoing recitations of the embodiments of the disclosure, it can be seen that the pluggable optical transceiver module of the disclosure uses the first fastening member to fasten the first cover to the first surface of the fixing block of the connector, and uses the second fastening member to fasten the second cover to the second surface of the fixing block. Accordingly, the first cover and the second cover can be fastened to the connector respectively by using the first fastening member and the second fastening member with short lengths. The first fastening member and the second fastening member with short lengths not only can achieve the purpose of making the first cover and the second cover clamp the connector, but also have better mechanical strengths and uneasy to be broken. Moreover, the pluggable optical transceiver module of the disclosure provides a separation mechanism design for separating from the optical signal interface. The separation mechanism design is convenient to users and effectively reduces the operating time of separating the pluggable optical transceiver module from the optical signal interface.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A pluggable optical transceiver module for connecting an optical signal interface, the optical signal interface having an elastic plate and the elastic plate having an aperture, the pluggable transceiver comprising:
a connector connecting an optical fiber cable and comprising a fixing block, the fixing block having a first surface and a second surface respectively located at two opposite sides of the fixing block, and the fixing block having a first fastening hole and a second fastening hole inwardly formed from the first surface and the second surface, respectively;
a first cover abutting against the first surface and having a first through hole communicated with the first fastening hole;
a second cover abutting against the second surface and having a second through hole communicated with the second fastening hole, and the second cover comprising a first engaging block engaged in the aperture;
a first fastening member fastened to the first fastening hole via the first through hole, so as to fix the first cover to the fixing block; and
a second fastening member fastened to the second fastening hole via the second through hole, so as to fix the second cover to the fixing block.

2. The pluggable optical transceiver module of claim 1, wherein the second cover has an inner surface and an outer surface, the first engaging block is located at the outer surface, the second cover has a slot, the slot runs through the second cover and is adjacent to the first engaging block, and the pluggable optical transceiver module further comprises:
a handle comprising a pivot rod, the pivot rod being pivotally disposed at the inner surface and having a protruding portion; and
a linking-up member pivotally disposed at the inner surface and having first end and a second end, wherein the protruding portion is located between the inner surface and the first end, and the second end is located over the slot,
wherein when the pivot rod rotates to make the protruding portion push the first end, the linking-up member is forced to rotate, so as to make the second end protrude out of the second cover via the slot and push the elastic plate to make the aperture leave the first engaging block.

3. The pluggable optical transceiver module of claim 2, wherein the inner surface of the second cover abuts against the second surface, so as to make the pivot rod and the linking-up member be retained between the second cover and the fixing block.

4. The pluggable optical transceiver module of claim 2, wherein two ends of the pivot rod protrude out of two opposite sides of the second cover, and the handle further comprises:
two side rods respectively connected to two ends of the pivot rod, wherein the side rods respectively have two end portions that extend to each other; and
a sleeve, wherein the end portions are respectively sleeved in the sleeve from two ends of the sleeve.

5. The pluggable optical transceiver module of claim 4, wherein the pivot rod, the side rods, and the sleeve form a ring, and the handle surrounds a periphery of the connector.

6. The pluggable optical transceiver module of claim 4, wherein the first cover comprises a second engaging block for engaging the sleeve.

7. The pluggable optical transceiver module of claim 1, wherein the first fastening hole and the second fastening hole are communicated with each other.

8. The pluggable optical transceiver module of claim 1, further comprising an optical signal processing portion, the optical signal processing portion being connected to the first cover and detachably accommodated in the optical signal interface.

9. The pluggable optical transceiver module of claim 1, wherein the connector is a ST (Straight Tip) connector.

10. The pluggable optical transceiver module of claim 1, wherein the connector and the optical fiber cable integrally form an AOC (Active Optical Cable).

11. The pluggable optical transceiver module of claim 1, wherein the first fastening member and the second fastening member are two screws, and the first fastening hole and the second fastening hole are two screw holes.

12. The pluggable optical transceiver module of claim 1, wherein the first fastening member and the second fastening member integrally form a rivet.
